(19) United States
(12) Patent Application Publication
(10) Pub. No.: US 2010/0259315 A1
(43) Pub. Date: Oct. 14, 2010

(54) Circuit and Methods for Temperature Insensitive Current Reference

(75) Inventor: Ching-Tzung Lin, Nantou City (TW)

Correspondence Address: SLATER & MATSIL, L.L.P., 17950 PRESTON ROAD, SUITE 1000, DALLAS, TX, 75252, US

(73) Assignee: Taiwan Semiconductor Manufacturing Company, Ltd., Hsin-Chu (TW)

(21) Appl. No.: 12/683,992

(22) Filed: Jan. 7, 2010

Related U.S. Application Data
(60) Provisional application No. 61/167,689, filed on Apr. 8, 2009.

(51) Int. Cl. G05F 1/10

(52) U.S. Cl. 327/538

(57) ABSTRACT

Circuits and methods for providing a temperature insensitive reference current are disclosed. A voltage source is received having a temperature coefficient. A first resistive element having a positive temperature coefficient and a second resistive element having a negative temperature coefficient are series coupled to form a resistor ladder. The reference current is generated by coupling the voltage source across the resistor ladder. The temperature coefficients of the first and second resistive elements are chosen to cancel the temperature coefficient of the voltage source. In another embodiment a temperature compensated voltage source is coupled to a resistor ladder of a first resistive element and a second resistive element, and the first resistive element has a positive temperature coefficient and the second resistive element has a negative coefficient; these cancel to form a temperature insensitive reference current. A method for forming a temperature insensitive reference current from resistive elements is described.

This application claims the benefit of U.S. Provisional Application No. 61/167,689, entitled “Circuit and Methods for Temperature Insensitive Current Reference,” filed on Apr. 8, 2009, which is incorporated herein by reference.

### TECHNICAL FIELD

The present invention relates to a circuit and methods for providing an improved temperature compensation scheme for generating reference currents in an integrated circuit fabricated on a semiconductor substrate. The use of the invention provides advantages in circuits to produce reference currents that are independent of temperature variations.

### BACKGROUND

A common requirement for an electronic circuit and particularly for analog or mixed signal electronic circuits manufactured as integrated circuits in semiconductor processes is a reference current, or a reference voltage. For a process variation and temperature independent voltage, prior art approaches use so called voltage “bandgap” circuits, or rely on proportional-to-absolute temperature (PTAT) circuits. The use of a PTAT circuit to produce a reference current, for example, requires a compensation scheme as the current will necessarily vary with temperature (proportional to absolute temperature). Some approaches use a complementary to absolute temperature (CTAT) circuit in addition to the PTAT circuit. The use of a fixed or temperature independent voltage to produce a current requires dividing a voltage in a resistor ladder. The current is obtained according to Ohm's law. However, resistive elements of the prior art include temperature coefficients and thus create temperature dependencies, so that the resulting reference current still varies with temperature, even in a situation where the input voltage is a bandgap voltage.

FIG. 1 depicts a simple current reference of the prior art. In FIG. 1, transistors MP11 and MP13 are PMOS transistors coupled to form a current mirror. A resistor R is used to form a current reference in one branch of the mirror and current Iref is generated. This current is then output as current lout by transistor MP13.

The expression for lout is simply

Iref=Iout=(Vdd−Vgs,p)/R. Vgs, p is a voltage drop due to the PMOS transistor.

In the prior art, the current Iref is simply determined by the resistor R. However, the resistor R has a temperature dependence, therefore the resulting reference current also has a temperature dependence. This type of circuit may be referred to as “proportional-to-absolute temperature” or as a PTAT current reference. To form a temperature independent current, the prior art may use diodes or p-n junctions, which have a negative temperature coefficient, to produce a current to balance the positive temperature coefficient current of a resistor. These approaches provide some temperature compensation, but as the temperature of a device varies over the range typically specified for a semiconductor device, −40 degrees Celsius to 125 degrees Celsius, substantial variations in the reference current (and any corresponding voltage reference) still occur. Advance semiconductor process which produce smaller devices and additional process variations make obtaining a temperature insensitive reference current from these known circuits impractical.

Thus, there is a continuing need for methods and circuits for a temperature insensitive current reference for use on a semiconductor device or integrated circuit. The circuit and methods for the temperature insensitive current reference should remain compatible with existing and future semiconductor processes for fabricating integrated circuits.

### SUMMARY OF THE INVENTION

These and other problems are generally solved or circumvented, and technical advantages are generally achieved, by embodiments of the present invention, which provides a current reference formed across resistors having both positive and negative temperature coefficients. By choosing the sizes and values of these resistors to compensate the temperature dependent values, a constant current may be provided and thus, a constant reference current may be formed over the specified operating temperature ranges for a semiconductor device.

In an exemplary embodiment, a current reference circuit is provided. A voltage source having a temperature coefficient is used to form a current by using a resistance formed of a positive temperature coefficient resistor in series with a negative temperature coefficient resistor. By adjusting the values of the resistors, a temperature insensitive current may be obtained.

In another exemplary embodiment, a current reference is formed receiving a temperature compensated voltage, for example from a bandgap reference. A reference current is formed by providing a resistance formed from a series arrangement of a positive temperature coefficient resistor and a negative temperature coefficient resistor. By adjusting the values for the two resistor elements, the temperature coefficients may cancel, thus providing a temperature insensitive reference current.

In additional exemplary embodiments, the series resistors having a positive temperature coefficient and a negative temperature coefficient are formed of doped semiconductor material resistors. In further additional embodiments, the negative temperature coefficient resistors are formed by implanting p-type donor atoms in polysilicon material. In yet further additional embodiments, the positive temperature coefficient resistors are formed by implanting n-type donor atoms in polysilicon material. In a further embodiment, a P+ polysilicon resistor without silicide is used as the negative temperature coefficient resistor and an N+ doped polysilicon without silicide resistor is used as the positive temperature coefficient resistor. Silicide is a process step.

In another exemplary embodiment, a method is provided, comprising determining the temperature coefficient of a voltage source to be used to form a reference current, selecting a positive temperature resistor and a negative temperature resistor having a ratio of x:y corresponding to the temperature coefficient needed to cancel the temperature coefficient of the voltage source; determining the total resistance value needed to generate a reference current of a predetermined value from the voltage source; and selecting the values for the positive and negative resistor elements that are to be arranged in series to satisfy the ratio x:y and the total resistance value.

Advantages of the use of the embodiments accrue because process elements are used to obtain the temperature compensation, so that no additional circuitry is required. Compared to prior art approaches, less current is consumed. Lower current variation means designs can be simpler.

This summary gives an overview of certain embodiments of the invention, and is not limiting. Additional features and advantages of the invention will be described hereinafter, which form the subject of the claims of the invention. It should be appreciated by those skilled in the art that the conception and specific embodiment disclosed might be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE FIGURES

For a more complete understanding of the present invention, and the advantages thereof, reference is now made to the following descriptions taken in conjunction with the accompanying drawings, in which:

FIG. 1 illustrates a prior art current reference circuit;

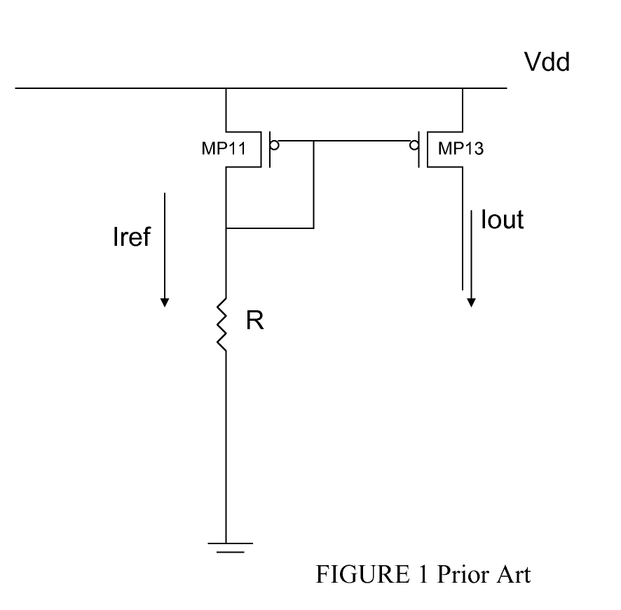

FIG. 2 illustrates in an exemplary circuit embodiment of the present invention, a temperature insensitive current reference;

FIG. 3a and FIG. 3b illustrate in graphs the temperature dependence of a current source such as the prior art circuit of FIG. 1 and the embodiment circuit of FIG. 2;

FIG. 4 illustrates in another exemplary circuit embodiment a current reference circuit coupled to a bandgap voltage source using features of the present invention;

FIG. 5a illustrates in a graph the temperature dependence of the bandgap voltage source of FIG. 4, FIG. 5b illustrates in a graph the current obtained over temperature using a prior art current reference coupled to the voltage bandgap, and FIG. 5c illustrates in a graph the temperature dependence of a reference current obtained using the embodiment depicted in FIG. 4; and

FIG. 6 illustrates in a flow diagram a method embodiment for forming a reference current circuit incorporating features of the invention.

The drawings, schematics and diagrams are illustrative, not intended to be limiting but are examples of embodiments of the invention, are simplified for explanatory purposes, and are not drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

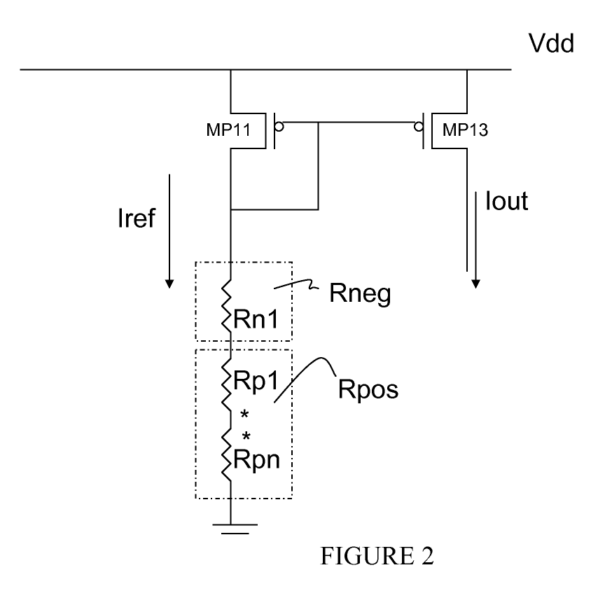

FIG. 2 depicts in one exemplary embodiment a block diagram of a temperature insensitive reference current circuit. In FIG. 2, P type MOSFET transistor MP11 is shown coupled to a positive voltage source Vdd. MP11 provides current to a resistor ladder formed of a negative temperature coefficient resistor Rneg and a positive temperature resistor Rpos. PMOS transistor MP13 is coupled with the gate and source terminals in common with MP11 and thus acts as a current mirror with MP11, producing an output current labeled Iout. Assuming the transistors MP11 and MP13 are matched devices with the same width, the current Iout may be equal to Iref. Those skilled in the art will also recognize that by scaling the two devices, the currents may have different magnitudes, corresponding to the ratio of the transistor device sizes.

The current Iref is simply given by the expression, from Ohms' law, of the current through a series resistance:

Iref=Vdd−Vgs, p/(Rneg+Rpos).

The resistors Rneg and Rpos may each be formed from one resistor or a series of resistors. For example, in this non limiting illustrative embodiment, the resistor Rneg is shown as a single resistor Rn1. In contrast, the resistor Rpos is shown as a series of resistors Rp1 . . . Rpn. Either resistor Rneg or Rpos may be varied in value by using either a larger or smaller value single resistor or by using a plurality of resistors in series to increase the value, or resistors may be coupled in parallel to decrease the value.

The resistors of the embodiments herein may be formed from doped polysilicon material. This feature of the present invention provides an important advantage. By using a p+type doped polysilicon for the resistor Rn1, a negative temperature coefficient is obtained. The resistance Rpos is formed from resistors Rp1 to Rpn. These resistors have a positive temperature coefficient. These resistors are obtained by forming an n+ doped polysilicon. By choosing the values of the resistors Rneg and Rpos correctly, a resistor that has a very small temperature dependence can be obtained, as contrasted with the PTAT current references of the prior art. In this way, a reference current that is largely temperature independent may be obtained. In this application, this is referred to as a “temperature insensitive” current. In one exemplary process, the Rneg resistors are described as “rppolywo”. The Rpos resistors are described as “rnpolywo”. These descriptors denote p-type polysilicon without silicide resistor (“rppolywo”) and n-type polysilicon without silicide resistor (“rnpolywo”). The “wo” of descriptors (rppolywo and rnpolywo) denote “without silicide”. Silicide is a process step.

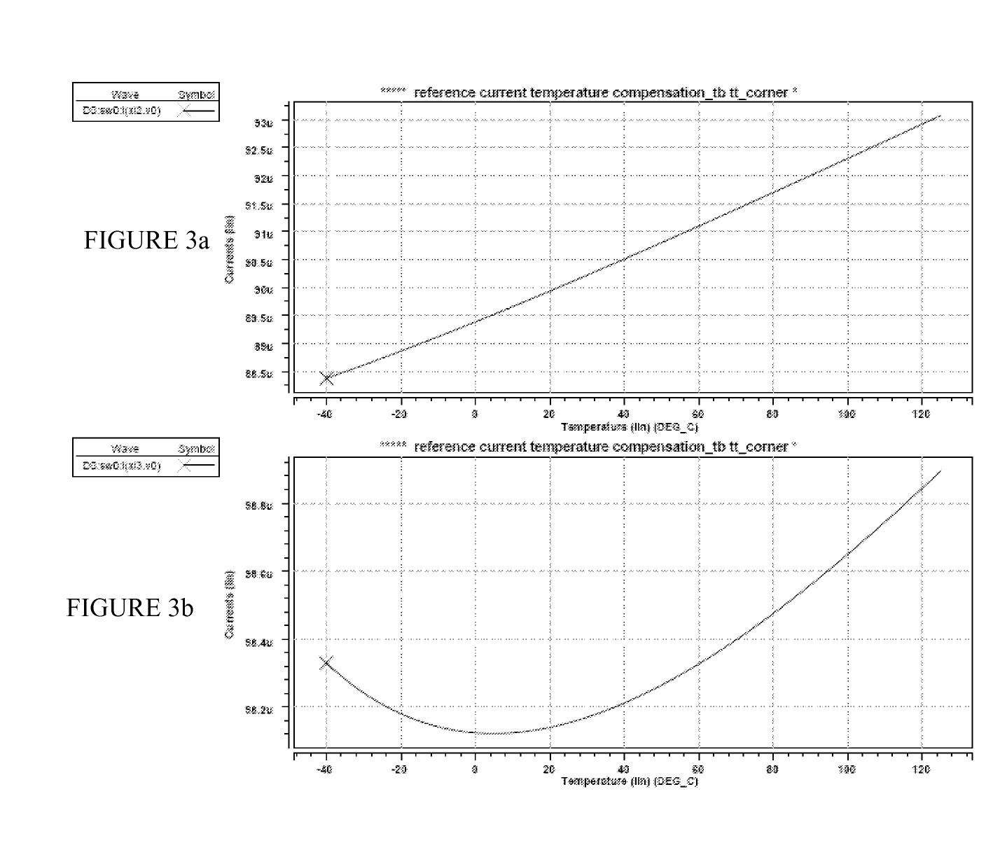

FIG. 3(a) depicts the temperature dependence of a prior art PTAT circuit using a typical resistor to form a current from a voltage. The current reference in this illustrative example has a positive temperature dependence which is shown as a linear curve with slope 0.0285 uA/degree Celsius, so that the current varies from a minimum of 88.4 uA at −40 degrees Celsius to a maximum of 93.1 uA at 125 degrees Celsius. In order to use this current as a reference current, the receiving circuit must be designed to be compensated or be insensitive to a large difference in this current as the integrated circuit temperature changes.

In FIG. 3b, a current reference that is formed by the circuit of FIG. 2 is depicted. The resistor values of the embodiment are chosen to cancel out the temperature dependence. The minimum current is at around 0 degrees Celsius and is 98.11 uA. In this illustrative example, the maximum at around 125 degrees Celsius is at 98.9 uA. The difference is less than 1 microamp and the slope is 0.00478 uA/degree Celsius, a major improvement. Thus, a receiving circuit using this output current as a reference current can treat it as a constant current.

In some applications, a reference current is taken from a voltage that is largely a temperature independent voltage. For example, the bandgap reference is often used to provide a voltage that is more or less temperature independent. However, a reference current formed using a constant voltage divided by a traditional semiconductor device resistor will still exhibit a large temperature dependence, because the resistor itself has a large temperature dependence. The embodiments of the present invention include circuits to output a constant reference current from a voltage that is temperature independent.

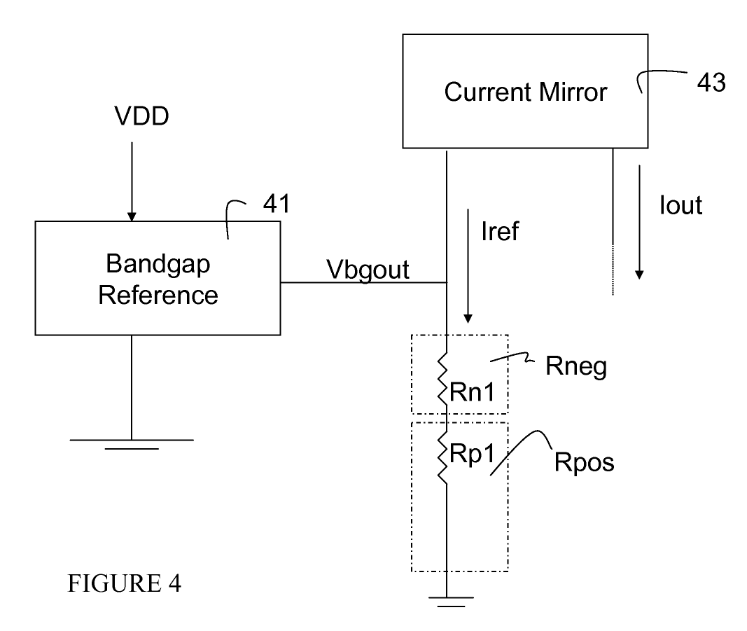

FIG. 4 depicts an alternative circuit embodiment for use in forming a reference current Iref from a voltage output by a bandgap circuit. In FIG. 4, a bandgap reference circuit 41 is provided having an output Vbgout. This voltage may be formed within the bandgap reference, for example, by using a PTAT current source in the form of a resistor having a positive temperature coefficient that is balanced with an element having a complementary temperature coefficient (CTAT current source), the currents through the elements are summed and then input to a resistor to form the output voltage Vbgout, so that the circuit is compensated for variations in temperature. Current mirror 43 then provides an equal or proportional output current Iout.

The reference current Iref developed in the embodiment illustrated in FIG. 4 is formed by dividing the bandgap reference voltage Vbgout by the doped polysilicon resistors Rneg and Rpos, connected in a series arrangement. The reference current Iref may be expressed as:

Iref=Vbgout/(Rneg+Rpos)

From the above equation, Iref may be a temperature insensitive current.

Thus, in this embodiment approach to form a temperature insensitive current from a temperature independent voltage, the temperature dependent resistor of the prior art circuits is replaced by a series arrangement of resistors, having a positive temperature coefficient (Rpos) and having a negative temperature coefficient (Rneg), so that the resulting total resistance R is independent of the temperature, and thus the current Iref is also temperature insensitive.

Unlike the current reference circuits of the prior art, embodiments of the present invention compensate for voltage sources that are temperature dependent and also in the same configuration with slight modification, temperature independent voltage sources. In either case, the circuit is formed using the same elements by simulating the temperature coefficient of the voltage source and compensating for the temperature dependence by choosing the values of resistors Rneg and Rpos. As described above, the resistors are preferably formed of doped polysilicon, with Rneg formed, for example, from p-type doped polysilicon to have a negative temperature coefficient (resistor value falls with increasing temperature) and Rpos formed, for example, from n-type doped polysilicon to have a positive temperature coefficient (resistor value increases with increasing temperature). Other implementations may be used as alternative embodiments that form resistor elements with positive and negative temperature coefficients, such as:

| | Temperature | |
|---|---|---|
| Name | Coefficient | Material |
| rnodwo | Positive TC resistor | N+ doped OD without silicide |
| rpodwo | Positive TC resistor | P+ doped OD without silicide |
| rnpolywo | Positive TC resistor | N+ doped polysilicon without silicide |
| rppolywo | Negative TC resistor | P+ doped polysilicon without silicide |
| rnwod | Positive TC resistor | N well under OD |
| rnwsti | Positive TC resistor | N well under STI |

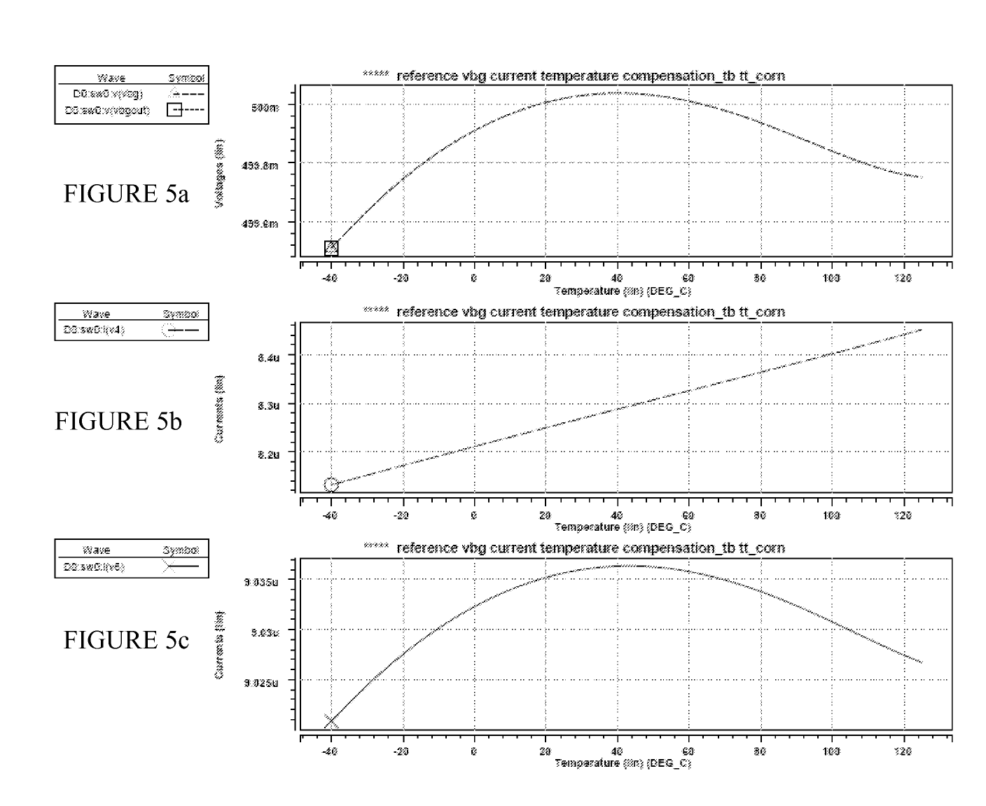

In the three graphs in FIG. 5a, FIG. 5b and FIG. 5c, simulation results are presented showing the operation of the prior art current reference, and in comparison, the embodiment of FIG. 4 when a typical bandgap reference is used as a temperature independent voltage source.

In FIG. 5a, the voltage output of the bandgap reference is plotted against temperature (shown in degrees Celsius) from −40 degrees C. to 125 degrees C. In this illustrative example, the bandgap puts out a voltage of 499.6 millivolts at −40 degrees and just over 500 millivolts maximum at about 40 degrees C., and the output then falls back to just under 499.8 millivolts at the upper temperature. The voltage output of the bandgap reference is relatively temperature independent, as expected.

In contrast, FIG. 5b illustrates the simulation results obtained for a prior art approach current reference, using a typical resistor formed in a semiconductor process, to provide a current from the voltage output by the bandgap. Because the current reference is a PTAT circuit, the current has a positive temperature coefficient and current increases with temperature. In this illustrative example, the current increases from a minimum of 8.13 uA at −40 degrees C. to a maximum of 8.45 uA at a temperature of 125 degrees C. The slope of the line is 0.00194 uA/degrees C., which corresponds to the positive temperature coefficient of the current source.

In FIG. 5c, the results obtained for the current Iref using the embodiment of the current source incorporating the temperature compensation resistors Rneg and Rpos of FIG. 4 are depicted. The minimum current is shown as 9.02 uA at −40 degrees C., the maximum current occurs at around 40 degrees C. and is 9.036 uA. The slope of this part of the curve is 0.000091 uA/degree C., corresponding to a temperature coefficient that is much lower than the prior art and in fact approaching zero. Note that because the resistance formed by the sum of the resistors Rneg and Rpos in FIG. 4 is temperature insensitive, the shape of the curve for the reference current Iref is very similar to the shape of the curve for the voltage bandgap output Vbgout. The resistors Rpos and Rneg have been selected to form a resistance that is temperature neutral and thus, the current Iref has only the slight temperature dependence remaining from the supply voltage to shape its temperature curve.

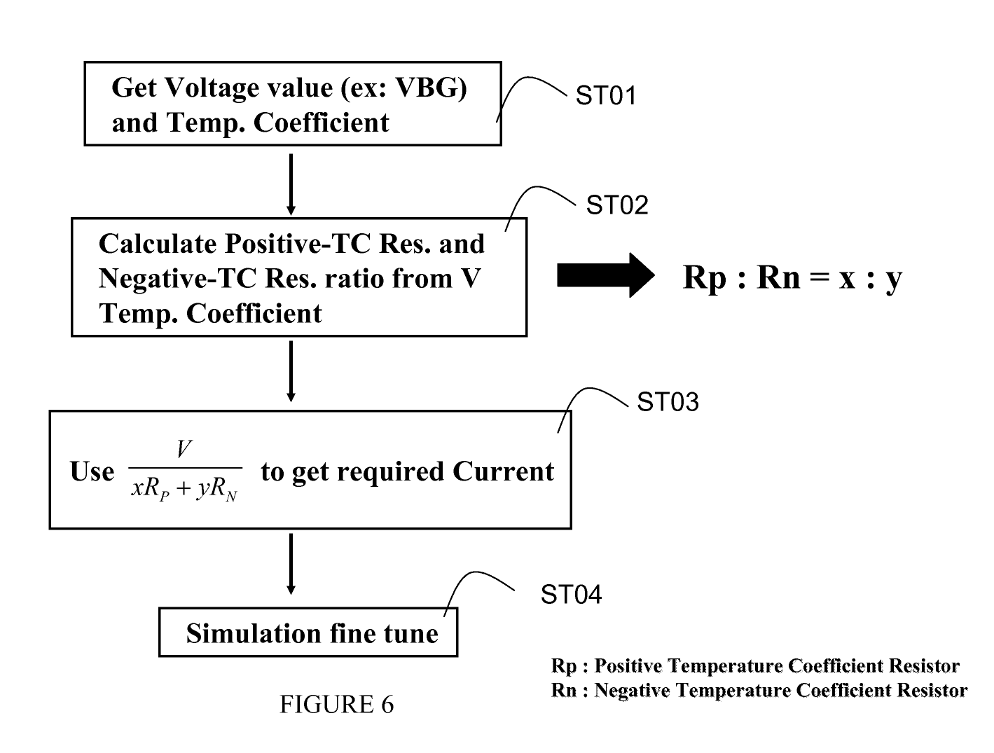

A method embodiment is now described for selecting the value of the resistors Rneg and Rpos to obtain a temperature insensitive current reference from a voltage source. In a flow diagram, FIG. 6 depicts the steps for the method. In step ST01, the voltage source is simulated and two quantities are determined, the nominal output value (example, VBG) and the temperature coefficient. The method then transitions to step ST02 in FIG. 6, where the ratio of the positive temperature coefficient resistors and the negative temperature coefficient resistors is determined as a ratio x:y, where x corresponds to the weight of the positive temperature coefficient resistor and y corresponds to the negative temperature coefficient needed to cancel the temperature coefficient (positive or negative) of the voltage source. In the next step ST03, the current needed is determined by choosing the resistor values needed to form a total resistor xRp+yRn so that the voltage over the resistor gives the desired current Iref. Finally, in step ST04, a circuit simulation is performed to check the temperature dependence of the resulting current Iref and to confirm that it is temperature insensitive.

Unlike the current reference circuits of the prior art, the use of the embodiment of the current reference having a combined resistor formed of positive and negative temperature coefficient resistors allows the embodiments of the invention to compensate for any desired voltage source to form a temperature insensitive reference current. These currents (and reference voltages) are often required for analog circuitry such as analog to digital converters (ADCs) and analog front ends for radio receivers, for example. Because the positive and negative resistors are formed using standard semiconductor process steps, the reference current circuits of the present invention may be combined with other circuitry including digital logic, embedded memory and the like for mixed-signal and system on a chip (SOC) integrated circuit applications. Alternatively, the temperature insensitive reference current generators may be used on pure analog circuitry or in power supply, analog sensor or other applications where no digital logic is used.

Advantages accrued by use of the embodiments of the present invention include: because process elements (doping) are used to compensate for temperature, no added circuitry is required. Compared to prior approaches, less current is consumed. The reference current has less variation, so the circuits receiving the reference current may be simpler in design.

Although exemplary embodiments of the present invention and its advantages have been described in detail, it should be understood that various changes, substitutions and alterations can be made herein without departing from the spirit and scope of the invention as defined by the appended claims. For example, it will be readily understood by those skilled in the art that the methods may be varied while remaining within the scope of the present invention.

Moreover, the scope of the present application is not intended to be limited to the particular embodiments of the methods and steps described in the specification. As one of ordinary skill in the art will readily appreciate from the disclosure of the present invention, processes, or steps, presently existing or later to be developed, that perform substantially the same function or achieve substantially the same result as the corresponding embodiments described herein may be utilized according to the present invention. Accordingly, the appended claims are intended to include within their scope such processes or steps.

What is claimed is:

1. A current reference circuit, comprising:
a voltage source having a temperature coefficient;
a first resistive element Rpos having a positive temperature coefficient; and
a second resistive element Rneg having a negative temperature coefficient;
wherein the first and second resistive elements are coupled in series and form a resistor coupled to generate a reference current insensitive to temperature variations from the voltage source.

2. The circuit of claim 1, wherein the voltage source has a positive temperature coefficient.

3. The circuit of claim 1, wherein the voltage source has a negative temperature coefficient.

4. The circuit of claim 1, wherein the voltage source outputs a voltage V and the reference current Iref is given by the expression Iref=V/(Rpos+Rneg).

5. The circuit of claim 4, wherein in the expression for Iref, the temperature coefficient of the voltage source is cancelled by the sum of the temperature coefficients for Rpos and Rneg.

6. The circuit of claim 1, wherein at least one of the first and second resistive elements are formed of two or more resistors.

7. The circuit of claim 1, wherein each of the first and second resistive elements is formed of semiconductor material doped to a conductivity type.

8. The circuit of claim 7, wherein the first resistive element is formed of polysilicon material doped with n-type dopant atoms.

9. The circuit of claim 7, wherein the second resistive element is formed of polysilicon material doped with p-type dopant atoms.

10. The circuit of claim 1, wherein the voltage source is coupled to a bandgap generator with a zero temperature coefficient.

11. A circuit for generating a reference current from a temperature compensated voltage, comprising:
a node coupled to a temperature compensated voltage source;
a first resistive element having a positive temperature coefficient; and
a second resistive element having a negative temperature coefficient;
wherein the first and second resistive elements are coupled in series and form a resistor generating the reference current insensitive to temperature variations from the voltage source.

12. The circuit of claim 11, wherein the sum of the positive temperature coefficient and the negative temperature coefficients approximate zero.

13. The circuit of claim 11, wherein the temperature compensated voltage source is a bandgap reference circuit.

14. The circuit of claim 11, wherein each of the first and second resistive elements is formed of semiconductor material doped to a conductivity type.

15. The circuit of claim 11 wherein the first resistive element is formed of polysilicon material doped with n-type dopant atoms.

16. The circuit of claim 11 wherein the second resistive element is formed of polysilicon material doped with p-type dopant atoms.

17. A method, comprising:
receiving a first voltage from a voltage source having a temperature coefficient;
providing a first resistive element Rpos having a positive temperature coefficient;
providing a second resistive element Rneg having a negative temperature coefficient; and
coupling the first and second resistive elements in series to form a resistor generating a reference current insensitive to temperature variations from the voltage source.

18. The method of claim 17, wherein providing a first resistive element further comprises providing at least one resistor formed of semiconductor material doped with n-type dopant atoms.

19. The method of claim 17, wherein providing a second resistive element further comprises providing at least one resistor formed of semiconductor material doped with p-type dopant atoms.

20. The method of claim 17, wherein the reference current Iref is given by the expression Iref=V/(Rpos+Rneg).
